(19) United States
(12) Patent Application Publication
(10) Pub. No.: US 2021/0135699 A1
(43) Pub. Date: May 6, 2021

(54) FLEXIBLE HANDLE ASSEMBLY FOR USE WITH PORTABLE ELECTRONIC DEVICES

(71) Applicants: Kerry HOFFMAN, Boca Raton, FL (US); Justin MATHESON, Jupiter, FL (US)

(72) Inventors: Kerry HOFFMAN, Boca Raton, FL (US); Justin MATHESON, Jupiter, FL (US)

(21) Appl. No.: 17/085,665

(22) Filed: Oct. 30, 2020

Related U.S. Application Data
(60) Provisional application No. 62/927,729, filed on Oct. 30, 2019.

(51) Int. Cl. H04B 1/3827; H04B 1/3888

(52) U.S. Cl. CPC H04B 1/385; H04B 2001/3861; H04B 1/3888

(57) ABSTRACT

Disclosed is a new novel flexible handle assembly for holding a portable electronic device. The assembly includes a flexible strap with a first end with a first cavity and a second end with a second cavity. The assembly further includes a first magnet disposed in the first cavity and a second magnet disposed in a second cavity. The magnets may be disk shaped. In one example a set of a first cap and a second cap are placed over the magnets to secure it into the respective cavities of the flexible strap. The assembly also includes a base for attaching to a handheld electronic device, the base with ferrous material. The ferrous material may be a pattern of separate lines. Example patters include a plurality of parallel lines, a plurality of concentric circles, or a combination thereof.

### CROSS-REFERENCE TO RELATED APPLICATIONS

This patent application is a based on and claims priority from U.S. Provisional Patent Application No. 62/927,729, filed on Oct. 30, 2020, which is hereby incorporated by reference in its entirety.

### BACKGROUND OF THE INVENTION

The present invention generally relates to accessories for portable electronic devices and more particularly relates to a detachable handle accessory for portable electronic devices.

Handheld or portable electronic devices, such as mobile phones, tablets, phablets, come in a variety of shapes and sizes. With these and other devices, there is often a need for two hands to complete a task on a device (e.g., texting using a mobile phone). Many times it is inconvenient to use two hands and/or the user may prefer or desire to use only a single hand when operating the device.

While various gripping handheld electronic devices have been devised (e.g., non-slip surface cases, finger loops, PopSockets®, kickstand-type arms), problems associated with single-handed handling of handheld electronic device have not been fully resolved.

### SUMMARY OF THE INVENTION

Disclosed is a new novel flexible handle assembly for holding a portable electronic device. The assembly includes a flexible strap with a first end with a first cavity and a second end with a second cavity. The assembly further includes a first magnet disposed in the first cavity and a second magnet disposed in a second cavity. The magnets may be disk shaped. In one example a set of a first cap and a second cap are placed over the magnets to secure it into the respective cavities of the flexible strap.

The assembly also includes a base for attaching to a handheld electronic device, the base includes a pattern of a separate lines of ferrous material disposed therein.

In one example the pattern of separate lines are formed so that each of the separate lines are non-overlapping and non-intersecting with any other of the separate lines and the first magnet and the second magnet of the flexible strap is magnetically secured to the base. One such pattern is separate lines formed as substantially parallel lines, for example concentric circles.

In another example the flexible strap further comprises a band with a first end with a first opening and a second end with a second opening and a first spring loaded pin placed inside the first opening for joining the band to the first end of the flexible strap and a second spring loaded pin placed inside the second opening for joining the band to second end of the flexible strap. The flexible strap is one of substantially barbell shaped or figure eight shape.

### BRIEF DESCRIPTION OF THE DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a perspective view of a detached flexible handle assembly for use with portable electronic devices;

FIG. 2 is an exploded view of FIG. 1;

FIG. 3 is a bottom view of FIG. 1;

FIG. 4 is a top view of FIG. 1;

FIG. 5 is an end view of FIG. 1 in which the design from each side are identical or a minor image thereof;

FIG. 6 is a side view of FIG. 1 in which the design from each side are identical or a minor image thereof;

FIG. 7 is an exploded perspective view of the ferrous portion of FIG. 1;

FIG. 8 is a perspective view of an attached flexible handle assembly for use with portable electronic devices;

FIG. 9 is a perspective view of an attached flexible handle assembly for use with portable electronic devices of FIG. 8 illustrating the flexed strap;

FIG. 10 is a perspective view of an attached flexible handle assembly for use with portable electronic devices of FIG. 9 illustrating the flexed strap with a user's finger(s) being inserted;

FIG. 11 is an exploded view of FIG. 1 of another embodiment with a removable base plate with ferrous material;

FIG. 12 is a top view of another embodiment of a base for use with portable electronic devices that have magnetics;

FIG. 13 is an end view of a base of FIG. 12;

FIG. 14 is an end view of a base plate of FIG. 12;

FIG. 15 is a perspective view of FIG. 14;

FIG. 16 is a side view of the base of FIG. 12;

FIG. 17 is a side view of the base plate of FIG. 14;

FIG. 18 is a top view of another embodiment of a handle assembly;

FIG. 19 is a cross-section side view of FIG. 18;

FIG. 20 is a perspective view of flexible band of FIG. 18; and

FIG. 21 is a base of FIG. 18.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term fastening means includes soldering, brazing, welding, glue, epoxy, and mechanical fasters such as bolts, screws and riveting or any combination thereof.

### Overall Structure and Components of Releasably Attached Handle

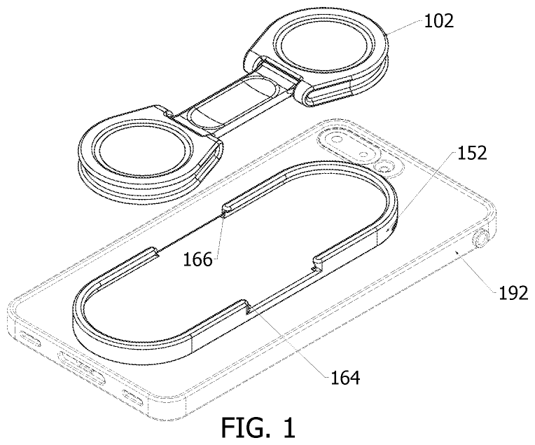

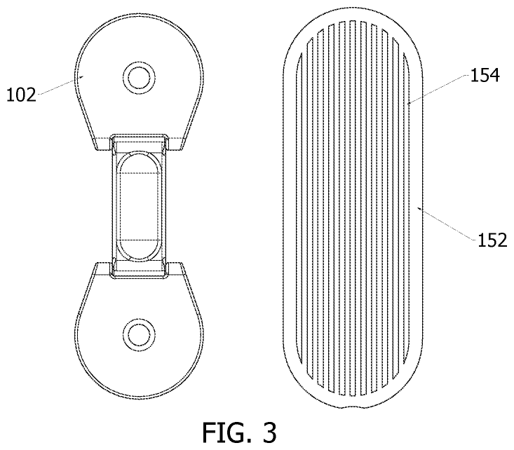

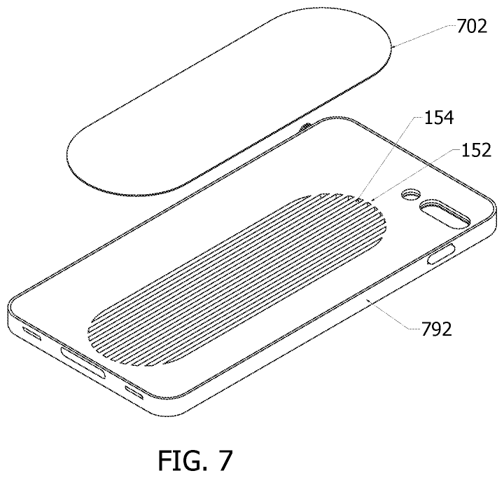

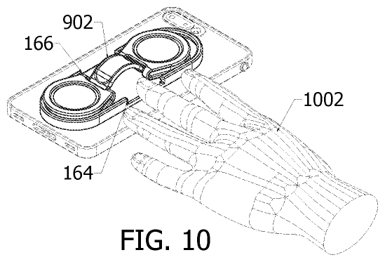

The present invention provides the ability to releasably attached handle for a portable electronic device. Turning now to FIG. 1 is a perspective view of a detached flexible handle assembly for use with a portable electronic device. There are two main components to the flexible handle assembly. A base 152 which is attached to the back of a handheld electronic device 192 and a flexible magnetic strap assembly 102. An optional finger recess 164 is also shown. This will be described further with reference to FIG. 10 below. The base 152 may also be integrated into an aftermarket handheld electronic device case. The base 152, as shown in FIG. 3 and FIG. 7, includes an open ferrous material pattern 154. Ferrous materials are magnetic. The ferrous materials typically contain iron, such as steel, stainless, carbon steel, cast iron, and other metals. One example of ferrous materials that has been shown to be used advantageously with the present invention is a permanent magnet made from neodymium magnet material. Other types of permanent magnets that are applicable are magnetic metallic elements, rare-earth magnets, composite magnets, nano-structured magnets or a combination thereof.

In one example the pattern of this magnetic material consists of parallel lines, concentric lines, concentric circles, or a combination thereof, that do not overlap, do no intersect, and are not electrically connected to each other. Stated differently in the pattern each of the lines are isolated from every other line in the pattern. Details of these open ferrous material patterns are illustrated in FIG. 7. Shown in FIG. 7 is an aftermarket smartphone case 792, showing the base 152 with open ferrous material pattern 154 and non-metallic cover 702.

Unlike various gripping devices, the present invention does not prevent the use of wireless charging because the base elements design. More specifically, the inventors discovered this pattern of magnetic material reduces interference of electromagnetic interference when the base 152 is used with through-surface wireless charging of the handheld electronic device 192.

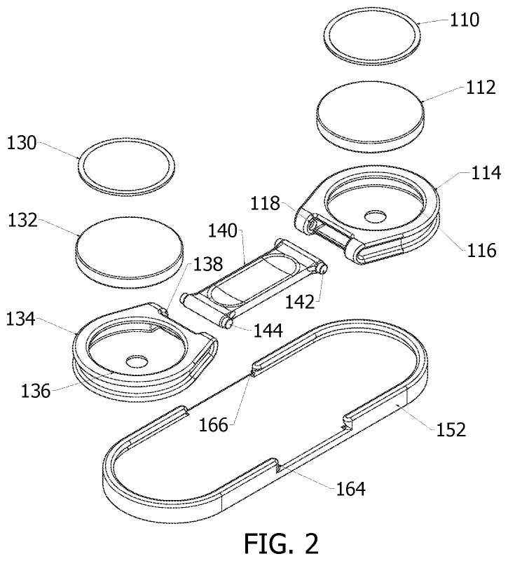

Turning to FIG. 2 is an exploded perspective view of a detached flexible handle assembly for use with portable electronic devices. The flexible magnetic strap assembly 102 is symmetrical from the middle with two ends 114, 134. Each end 114, 134 includes openings 116, 136 to receive magnets 112, 132 respectively. In one example the magnets 112, 132 are disk shaped but other shapes are also possible. A substantially inverted U-shape caps, badges or covers 110, 130 are adapted to cover the magnet 112, 132 in each cavity or opening 116, 136. The cover 110, 130 includes an outer ring and a center portion, typically made of clear plastic that does not block or reduce the magnetic field. In another example the magnets 112, 132 are directly molded into each end 114, 134.

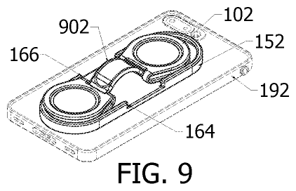

The flexible magnetic strap assembly 140, like a watch strap, can be made of any flexible organic or inorganic material including rubber, plastic, leather, or a combination thereof. In one example, like a watch band, each end of the flexible magnetic strap assembly 140 includes two ends with pressure or spring loaded pins 142, 144. The ends of each of the pressure pins 142, 144 engage a pair of holes 118, 138 formed in end 114, 134. This attachment combined with the flexibility of the band, enables the flexible magnetic strap assembly 102 to create an adjustable loop with an opening 902 (in FIG. 9 and FIG. 10) between the flexible magnetic strap assembly 102 and the base 152.

In another example instead of the spring loaded pins 142, 144 are made from plastic. The two ends 114, 134 are formed from deformable rubber. The use of deformable rubber allows the user to squeeze each end 114, 134, while the magnets 112, 132 and cap 130 and 110 are removed, thereby expanding the distance between the pair of holes 118 at end 114 and holes 138 and end 134 This expansion of the distance enables the plastic pin to be removed.

In still another example, like a band used on an Apple® Watch, the flexible magnetic strap assembly 140 can be made to slide in and out of a groove (not shown) formed on each end 114, 134.

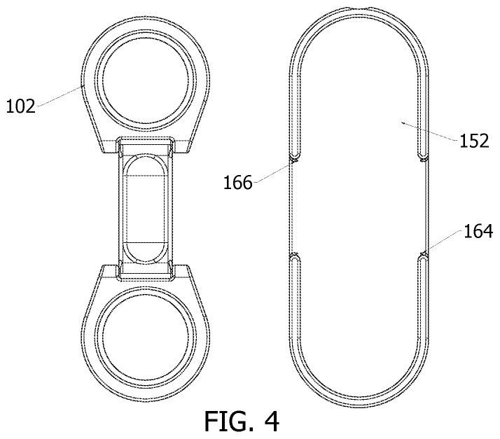

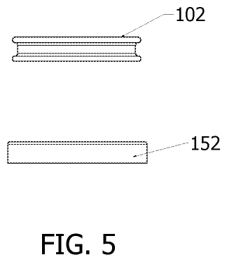

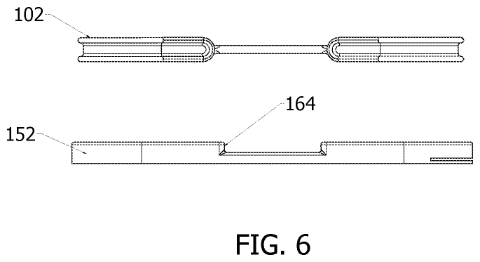

Turning now to FIG. 3 is a bottom view of FIG. 1. Shown are the two main components. A base 152 which is attached a back of a handheld electronic device 192 and the flexible magnetic strap assembly 102. The base 152 illustrates one example of an open ferrous material pattern 154 consisting of parallel lines that are not electrically connected. FIG. 4 is a top view of FIG. 1. FIG. 5 is an end view of FIG. 1 in which the design from each side are identical or a minor image. Likewise FIG. 6 is a side view of FIG. 1 in which the design from each side are identical or a mirror image.

FIG. 7 is an exploded perspective view of the ferrous portion of FIG. 1. Shown is an aftermarket smartphone case 792, showing the base 152 with open ferrous material pattern 154 and non-metallic cover 702.

It is important to note that the base 152 may be integrated in a case for a portable electronic device or place using adhesive on one side attached to the case (not shown) or adhesive tape, such as 3M® double-sided tape, which comes in various adhesive strengths for permanent bonding and semi-permanent applications.

Lastly, for certain portable electronic devices such as the Lenovo MotoZ® series and the Apple iPhone® 12 series with ferrous material or ferromagnetic as integrated directly into the casting. The present invention works with these features as well. In this example, the base 152 may be eliminated. The magnets 112, 132 in the flexible magnetic strap assembly 140 will work with the magnets on in the phone's casting (not shown).

### Operation and Example Use of Releasably Attached Handle

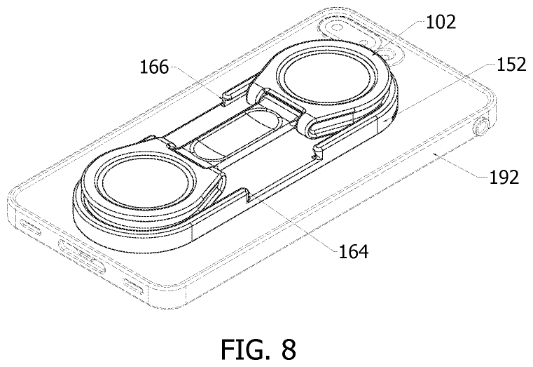

Turning now to FIG. 8 is a perspective view of an attached flexible handle assembly for use with portable electronic devices. Shown are the two main components: a base 152 attached to a back of a portable electronic device. The open ferrous pattern 154 disposed in the base 152 is magnetically coupled to magnets 112, 132 of FIG. 2. Note that the flexible magnetic strap assembly 140 is substantially flat against the base 152 as shown.

FIG. 9 is a perspective view of an attached flexible handle assembly for use with portable electronic devices of FIG. 8 illustrating the flexible magnetic strap assembly 140 being flexed forming an opening 902. Note that the size of the opening 902 can be adjusted to be larger by moving the ends 114, 134 towards each other. Likewise, the opening 902 can be made smaller by moving the ends 114, 134 further apart.

FIG. 10 is a perspective view of an attached flexible handle assembly for use with portable electronic devices of FIG. 9 illustrating the handle being flexed with a user's finger(s) 1002 being inserted into the opening 902 according to one example of the invention.

It is important to note that although fingers are shown to be inserted into the opening 902 that the opening 902 can be formed around other items such as a rail on a grocery shopping cart, a mount for a car or boat or desk or any other structure capable of being held within the opening 902.

When the flexible magnetic flexible band 102 is flat against the base 152, the optional finger recess 164 makes it easier for a user to pull the flexible magnetic flexible band 102 away from the base 152.

### Customizations of Strap and Covers

The present invention allows customization of the flexible magnetic strap assembly 140 and/or cap or cover 110, 130 of FIG. 2. Customizations include materials, colors, graphics, logos, advertisement, or a combination of these in which the user can mix and match.

### Removable Base Plate Example

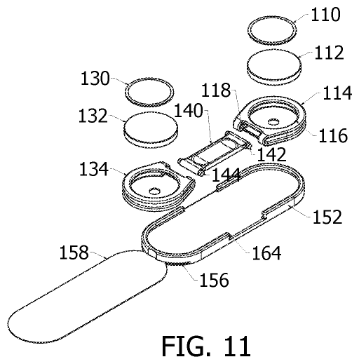

FIG. 11 is an exploded view of FIG. 1 of another embodiment with a removable base plate 158 with ferrous material. In this embodiment, the base plate 158 which includes an open ferrous material pattern 154 as described above, is slidable into a set of channels or grooves 156 formed in a side of the base 152 as shown. Although the grooves 156 are formed on one end, the grooves may be formed on any side of the base 152. In this example, with the base plate 158 removable, any ferrous pattern (not shown) may be used. Also the base-plate 158 may be made from a ferrous metal to enable wireless charging when removed from the base 152.

First Example of Flexible Handle Assembly for Portable Electronic Device with Circular Magnets

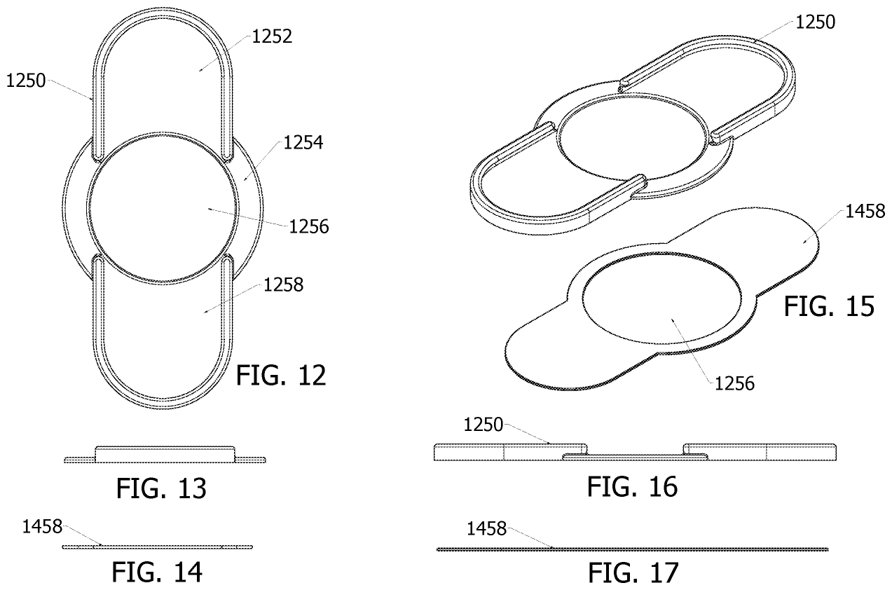

FIG. 12 is a top view of another embodiment of a base for use with portable electronic devices. In this example the base is adapted to be used with a portable electronic device that have magnets integrated in the casting. Contrast integrated with casting of the portable electronic device itself is contrasted with aftermarket covers or cases. Examples of portable electronic devices with built-in magnets include the Lenovo MotoZ® series and the Apple iPhone® 12 series with ferrous material or ferromagnetic as integrated directly into the casting. In this example, the base 1250 includes a first end 1252 and a second end 1258. Each of the first end 1252 and the second end 1258 are joined by a semicircular center portion 1254 as shown. The semicircular center portion 1254 has an opening 1256. The opening 1256 allows the built-in magnets of the portable electronic device casting to still be used with other accessories such as wireless chargers.

The opening 1256 may include plastic or non-ferrous caps or covers (not show) that do not block the magnetic field. These covers could be customized with colors, graphics, logos, advertisement, or a combination of these in which the user can mix and match.

The remaining figures in this example are now briefly described. FIG. 13 is an end view of a base 1250 of FIG. 12 and FIG. 14 is an end view of a base plate 1458 of FIG. 12. The base plate 1458 can either be formed within the base 1250 or attached with adhesive. Continuing further FIG. 15 is a perspective view of FIG. 14 and FIG. 16 is a side view of the base 1250 of FIG. 12. Finally FIG. 17 is a side view of the base plate 1458 of FIG. 14.

Second Example of Flexible Handle Assembly for Portable Electronic Device with Circular Magnets

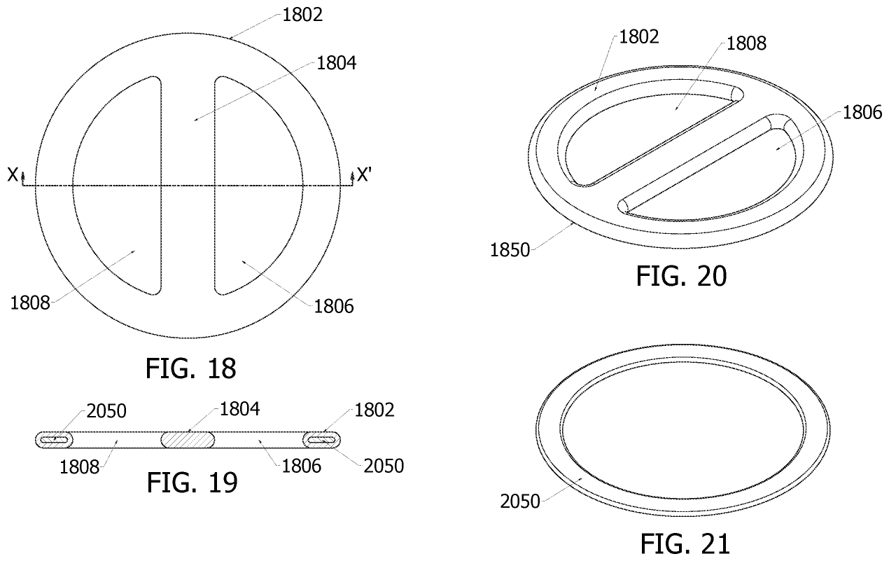

Turning now to FIG. 18 is a top view of another embodiment of a handle assembly. In this example an oval shape 1802 is shown. The oval shape 1802 is includes at least one center rib 1804 that define two open portions 1806, 1808. Other ribs may be included in another example. FIG. 19 is a cross-section side view along X-X′ of FIG. 18 showing a metallic or ferrous ring 2050 of FIG. 21. FIG. 20 is a perspective view of flexible band of FIG. 18. The rib 1804 is flexible enough to allow a user to put a finger or fingers through to grasp the portable electronic device when attached. The rib made formed from same material as oval shape 1802 or some other material. These materials include rubber, plastic, leather or other organic or inorganic materials.

FIG. 21 is a perspective view of a metallic or ferrous ring 2050 of FIG. 18. The ferrous ring 2050 may be incorporated as part of molding process directly inside the oval shape 1802. In other example the ferrous ring 2050 is attached to the bottom 1850 of the oval shape 1802 using adhesive. The ferrous ring 2050 is sized and designed to magnetically couple to with ferrous material or ferromagnetic as integrated directly into the casting of the portable electronic device (not shown).

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A handheld electronic device holding apparatus comprising:
a flexible strap with a first end with a first end with a first cavity and a second end with a second cavity;
a first magnet disposed in the first cavity and a second magnet disposed in a second cavity; and
a base for attaching to a handheld electronic device, the base includes a pattern of a plurality of separate lines of ferrous material disposed therein.

2. The handheld electronic device holding apparatus of claim 1, wherein the pattern of a plurality of separate lines are formed so that each of the separate lines are non-overlapping and non-intersecting with any other of the separate lines and the first magnet and the second magnet of the flexible strap is magnetically secured to the base.

3. The handheld electronic device holding apparatus of claim 1, wherein flexible strap further comprises:
a band with a first end with a first opening and a second end with a second opening; and
a first spring loaded pin placed inside the first opening for joining the band to the first end of the flexible strap and a second spring loaded pin placed inside the second opening for joining the band to second end of the flexible strap.

4. The handheld electronic device holding apparatus of claim 1, further comprising a first cap for placing over the first magnet in the first end of the flexible strap for securing the first magnet in the first cavity and a second cap for placing over the second magnet in the second end of the flexible strap for securing the second magnet in the second cavity.

5. The handheld electronic device holding apparatus of claim 1, wherein the flexible strap is one of substantially barbell shaped or figure eight shape.

6. The handheld electronic device holding apparatus of claim 1, wherein the pattern of a plurality of separate lines are formed as substantially parallel lines.

7. The handheld electronic device holding apparatus of claim 1, wherein the pattern of a plurality of separate lines are formed so be substantially concentric circles.

8. The handheld electronic device holding apparatus of claim 1, wherein the first magnet and the second magnet are disk-shaped magnets.

9. The handheld electronic device holding apparatus of claim 1, further comprising:
a handheld electronic device with the base attached thereto.

10. The handheld electronic device holding apparatus of claim 1, further comprising:
a base plate with the pattern of a plurality of separate lines of ferrous material disposed therein; and
wherein the base includes a set of grooves for slidably accepting the base plate thereinto.

11. A flexible handle assembly for use with a portable electronic device, the flexible handle assembly comprising:
a base with a ferrous material; and
a flexible handle, with a first end and a second end mechanically coupled to each other with a flexible strap, a first magnet disposed in the first end and a second magnet disposed in second end.

12. The flexible handle assembly of claim 11, wherein the ferrous material is patterned in a one of a plurality of parallel lines, a plurality of concentric circles, or a combination thereof and which each of the parallel lines is not electrically connected to any other of the parallel lines and each of the plurality of concentric circles is not connected to any of the concentric circles.

13. The flexible handle assembly of claim 11, further comprising:
a first pressure pin used to engage the first end to a first end of the flexible handle; and
a second pressure pin used to engage the second end to a second end of the flexible handled.

14. The flexible handle assembly of claim 11, further comprising:
a first cavity in the first end formed to accept the first magnet; and
a second cavity in the second end formed to accept the second magnet.

15. The flexible handle assembly of claim 13, wherein the first magnet and the second magnet are disk shaped.

16. The flexible handle assembly of claim 11, further comprising:
a base plate with ferrous material with a ferrous material patterned with the one of a plurality of parallel lines, a plurality of concentric circles, or a combination thereof; and
wherein the base includes a set of grooves for slidably accepting the base plate thereinto.

17. A handheld electronic device holding apparatus comprising:
a flexible strap with a first end with a first end with a first cavity and a second end with a second cavity;
a first magnet disposed in the first cavity and a second magnet disposed in a second cavity; and
a base for attaching to a handheld electronic device, the base includes a base plate with ferrous material and the base includes a set of grooves for slidably accepting the base plate thereinto.

18. The handheld electronic device holding apparatus of claim 17, wherein the ferrous material is patterned in a one of a plurality of parallel lines, a plurality of concentric circles, or a combination thereof.

19. The handheld electronic device holding apparatus of claim 17, further comprising a first cap for placing over the first magnet in the first end of the flexible strap for securing the first magnet in the first cavity and a second cap for placing over the second magnet in the second end of the flexible strap for securing the second magnet in the second cavity.

20. The handheld electronic device holding apparatus of claim 17, wherein the first magnet and the second magnet are disk-shaped magnets
